(19) United States
(12) Patent Application Publication
(10) Pub. No.: US 2004/0073798 A1
(43) Pub. Date: Apr. 15, 2004

(54) System of controlled certificate production and management

(76) Inventors: Thomas F. Look, Ham Lake, MN (US); Liu Yubao, Shanghai (CN); Mao Jianyong, Shanghai (CN); Zhang Wei, Shanghai (CN); Craig A. Schmidt, Lindstrom, MN (US); Qui Tian, Shanghai (CN); Chen Wei, Shanghai (CN); Huang Tien-Hsiagn, San Chung City (TW); Ji Hong, Shanghai (CN); Robert T. Krasa, Hudson, WI (US); Jeremy P. Gundale, Brownwood, TX (US)

Correspondence Address: 3M INNOVATIVE PROPERTIES COMPANY, PO BOX 33427, ST. PAUL, MN, 55133-3427, US

(21) Appl. No.: 10/458,593

(22) Filed: Jun. 10, 2003

Related U.S. Application Data
(60) Provisional application No. 60/389,060, filed on Jun. 13, 2002.

(51) Int. Cl. H04L 9/00; G06K 7/10

(52) U.S. Cl. 713/175; 713/176; 235/462.01

(57) ABSTRACT

Techniques are described for distributed production of controlled certificates, such as license plates for motor vehicles, in a secure manner. Controlled certificates may be printed at a local branch office subject to the control of a client computer. A server computer may regulate the operations of the client computers at the branch offices. The production system includes any of several security features to deter forgery and counterfeiting. For example, the security components that make up a finished controlled certificate may be separately secured with unique security elements. The finished controlled certificate may also have a unique security element.

This application claims priority from U.S. Provisional Application Serial No. 60/389,060, filed Jun. 13, 2002.

### TECHNICAL FIELD

The invention generally relates to controlled certificates and, more particularly, techniques for generating controlled certificates such as license plates.

### BACKGROUND

There are many contexts in which a central entity regulates the issuance of controlled certificates, which document personal identities, motor vehicle identities, authorizations, rights of ownership, permission to travel, proof of payment of fees, completion of training and so forth. Examples of controlled certificates include license plates for motor vehicles, validation and registration stickers for motor vehicles, driver licenses, passports, visas, and forms of personal identification. Production of controlled certificates may be monitored to prevent forgery or counterfeiting. For security purposes, controlled certificates may be generated at a centralized production facility.

License plates, for example, have been produced using several methods. A common conventional method to produce a license plate is to laminate retroreflective sheeting (hereinafter also referred to as sheeting) to a sheet of metal such as aluminum or steel, die cut a blank in the shape of the license plate, emboss identifying characters in the blank, and roll coat the characters with a colorant. The hardware and labor needed for this production technique may be centralized at a production facility. Finished license plates may be transported from the production facility to local offices for distribution to customers.

Some jurisdictions permit customers to order customized license plates. The license plates may be customized to include a particular plate design, a desired identifier, such as a sequence of alphanumeric characters, or a combination of both. Assuming the customer's desired license plate is authorized, the customer may submit a special order for the license plate.

### SUMMARY

In general, the invention is directed to techniques for centrally managing the distributed production of controlled certificates, such as license plates for motor vehicles, in a secure manner. For example, license plates of various classifications may be generated locally at distributed locations within a given jurisdiction, subject to the control of the central entity charged with issuing license plates. Although the invention may be applicable to a variety of controlled certificates, such as, for example, drivers' licenses, passports, visas and validation and registration stickers for motor vehicles, license plates for motor vehicles will be described for purposes of example.

In general, a system for distributed license plate production can be characterized by a distributed architecture, in which local production is controlled by client computers at branch offices. One or more server computers regulate the operations of the distributed client computers, and help in reducing issuance of fraudulent or otherwise inaccurate license plates.

The server computer manages a jurisdictional database of license plate information. In response to a plate request from a branch office, the server computer searches the jurisdictional database to determine whether the plate request is valid. In a typical application, a customer may make a request at a branch office for a plate having a particular identifier, such as a desired combination of letters and/or numbers. The server computer may determine, for example, whether that identifier has been previously issued to another customer. If the plate request is valid, the server computer may authorize a client computer to produce a license plate bearing the requested identifier. If the plate request is invalid for some reason, the server computer may deny authorization.

In some embodiments, the ability of the client computer to print the requested license plate may be disabled unless authorized to do so by the server computer. When printing is authorized, the client computer prints the identifier to a panel of film (i.e., a particular piece or section of film conforming to the dimensions of a license plate and to be used as the top film). The printed film panel is bonded to a license plate blank. In this manner, the central server computer may exert control over the printing tasks assigned to the client computers.

Security is of major importance in the production of controlled certification (e.g. license plates). For this reason, the invention may provide several measures to prevent or deter forgery and counterfeiting. For example, panels and the blanks used to produce the plates are examples of components that can be separately secured. Each panel and blank may include, for example, a unique security element. The security elements may include encrypted information. The security elements make fraud difficult, and also may be used to track panels and blanks independently. These security elements may be present in the top film panels and blanks before the panels and blanks are received by a branch office.

Alternatively or in addition thereto, a branch office may form one or more security elements on at least one of the components, e.g. top film panels and/or blanks and/or the finished controlled certificate. The security elements, which may also include encrypted information, may be unique to the particular license plate. A finished license plate may be scanned to verify that the license plate includes a valid panel and a valid blank. In particular, a security element may be optically or electromagnetically scanned to obtain the encrypted information. The scanned information then may be analyzed to verify that it corresponds to the proper encryption routine or other security procedure.

In addition, the production system may include several security features. For example, communications between the client computer and the server computer may be encrypted. Printing operations may be performed under the control of the client computer, with authorization from the server computer, and with unauthorized printing being thwarted by devices such as passwords and encryption keys required locally at the client computer.

The invention may provide many advantages. Local printing and distribution of license plates may be convenient and efficient for the issuing authority as well as the customer. Furthermore, the system may include different levels of security that may deter or prevent forgery and counterfeiting.

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIG. 1 is a block diagram illustrating an example distributed license plate production system.

FIG. 2 is a flow diagram illustrating a request for authorization of a plate request by a client computer, an authorization or denial of the request by a server computer, and the response of the client computer to the authorization or denial.

FIG. 3 is a perspective view of exemplary security components and security features of a license plate.

FIG. 4 is a flow diagram illustrating printing and security techniques employed by a client computer in a branch office.

FIG. 5 is a perspective drawing of an automated digital license plate production system.

FIG. 6 is a flow diagram illustrating inventory and security techniques employed by a server computer.

### DETAILED DESCRIPTION

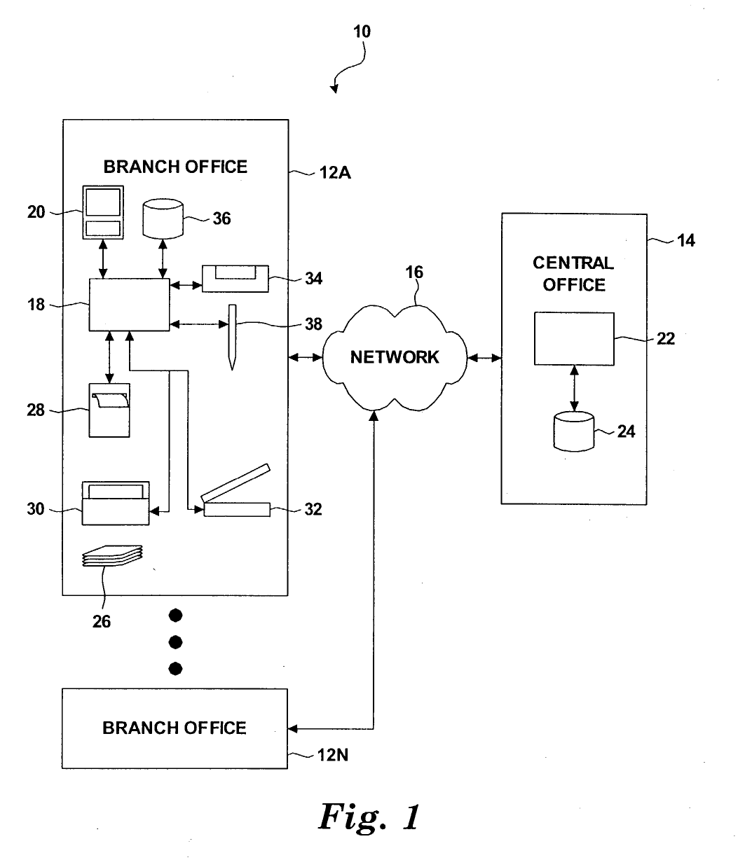

FIG. 1 is a block diagram illustrating a distributed license plate production system 10. System 10 is an example of a system for centrally managing the distributed production of controlled certificates, and in particular, controlled certificates in the form of license plates. More specifically, authorized local branch offices 12A through 12N, collectively referred to as branch offices 12, interact with central office 14 via network 16 to create and distribute license plates. In a typical application, central office 14 may be a central (e.g., governmental) entity charged with issuing license plates and keeping license plate records, and branch offices 12 may be the local motor vehicle departments. Branch office 12 and central office 14 need not be remote from one another, however, and in some applications, branch office 12 and central office 14 may share common facilities.

Network 16 represents any communication link suitable for communicating data, such as a wide-area network, local area network, or a global computer network like the World Wide Web. Although license plate production will be described herein for purposes of illustration, various embodiments of the invention can be adapted to other types of controlled certificates, and in particular validation and registration stickers for license plates.

Distributed license plate production system 10 allows branch offices 12 to generate license plates for customers, subject to the control of central office 14. A customer may enter a branch office 12 and have one or more license plates prepared for him at the branch office while he waits. The customer may also request one or more license plates having a particular identifier such as a customized set of letters and numbers, e.g., a so-called “vanity” plate, and have the customized license plates prepared while he waits.

The customer's license plate request may be entered into a client computer 18. Client computer 18 receives information entry via an input/output device such as a workstation 20. The invention encompasses embodiments in which the data may be entered by an operator as well as embodiments in which the customer enters the data, e.g., in a “self-service” mode.

In addition to a desired customization, if any, data may be entered pertaining to the vehicle, such as make, model and identification number. Data may also be entered pertaining to the customer, such as a personal identification number, address, and driving permissions or restrictions. Data may also be entered pertaining to the classification of the requested license plate. Different jurisdictions may supply different forms of license plates for different classifications of vehicles, such as automobiles, trucks, motorcycles, trailers, law enforcement vehicles, foreign vehicles, diplomatic vehicles, vehicles for hire, vehicles operated by handicapped drivers, veteran-owned vehicles, and the like. Also, different classes of drivers may be represented, e.g., chauffeur, taxi driver, long-haul drivers, and the like.

Client computer 18 forwards the license plate request to a server computer 22 in central office 14 via network 16. Server computer 22 grants or denies the request. The request may be denied for any of several reasons. For example, the request may be denied if the identifier requested by the customer is restricted or has been previously assigned to another customer as shown by a search of a jurisdictional database 24. When the request is denied, server computer 22 transmits the denial via network 16 to client computer 18, and client computer 18 is not authorized to print the license plate.

When the request is granted, server computer 22 transmits an authorization via network 16 to client computer 18 and instructions to print the license plate. Client computer 18 regulates printing of the license plate according to the instructions of server computer 22. In particular, client computer 18 may be disabled from printing the license plate unless authorized by server computer 22.

A controlled certificate comprises at least two components that make up the controlled certificate. The at least two components at minimum are characterized by separate layers when viewed in cross-section. The separate layers often differ in composition. Typically, each component has sufficient structural integrity such that it may be provided preformed (e.g. as a roll-good) alone or disposed upon a release liner. At least two of the and optionally each of the components preferably comprises a security element. Accordingly, in a preferred embodiment, the controlled certificate of the invention (e.g. license plate, validation and registration stickers) comprises a first component comprising at least one first security element and a second component comprising at least one second security element. The first security element may be the same as, yet is preferably different than the second security component. At least one of the security elements and optionally both the first and second security elements uniquely identify the component, and thus the finished controlled certificate.

In the case of a license plate, the (e.g. security) components may comprise a blank with (e.g. retroreflective) sheeting bonded thereto. The blank may be made of a durable material such as steel, aluminum, or plastic. Blanks may include physical features of license plates, such as rounded corners and mounting holes. Branch office 12 typically has a supply of blanks 26. In this embodiment, the blank is a first (e.g. structural) component and the sheeting is a second (e.g. structural) component.

Alternatively, however, the controlled certificate may comprise retroreflective sheeting having a layer comprising retroreflective elements as a first component and a transparent cover layer (e.g. top film or coating). A second security element is typically present in such cover layer. Optionally however, a second security element may be disposed between the blank and the cover layer. Further, yet typically less durable, the second security element may optionally be applied to an exposed surface of the controlled certificate. In the later embodiments, the branch office may form or apply the second security element.

In one embodiment, a retroreflective sheet is employed comprising microspheres dispersed throughout a binder layer with an underlying specular reflective layer spaced from the microspheres by the binder layer. Suitable binder layer materials include polyvinyl butyral, aliphatic polyurethane and polyurethane extended polyethylene terephthalate (PET) polymers (e.g., described at column 15, lines 30-35 of U.S. Pat. No. 5,882,771). The specular reflective layer may be a vapor deposited aluminum film. A pressure sensitive adhesive layer may be applied to either or both sides of the retroreflective sheet. The pressure sensitive adhesive layer may be temporarily covered with a removable liner. A suitable pressure sensitive adhesive is described, for example, in U.S. Pat. No. 6,197,397. The adhesive may have a removable release liner to facilitate handling, such as described in U.S. Pat. No. 5,897,930. Suitable retroreflective sheeting is available from 3M Company of St. Paul, Minn. under the trade designation “Scotchlite Reflective License Plate Sheeting Series 3750/3770.”

Although the blank may be optionally printed, typically a printer 28 in branch office 12 prints the informational content of the license plate to a top film. The top film may be a transparent polymer, such as vinyl, comprising a plurality of panels. In a typical application, the top film is delivered to branch office 12 on a roll, with the panels scored or die-cut for easy separation from the roll. Alternatively, a transparent coating may be employed in place of a top film.

In one embodiment of the invention, the mirror image of the informational content of the license plate is printed to a panel of the top film with printer 28. The panel is separated from the sheeting and is bonded to a blank, with the printed side disposed between the blank and the top film. In this way, bonding the panel to the blank produces a true image of the informational content.

Printer 28 may be a digital printer. As an example, printer 28 may be a thermal imaging printer that transfers colorant from a donor, such as a thermal transfer ribbon, to a receptor, such as a panel. Printer 28 may include a plurality of heating elements, such as resistive heating elements, that may be selectively activated and/or deactivated to transfer colorant from the donor to the receptor. Any graphical information may be printed, including letters, numbers, pictorial characters such as Chinese characters or Japanese kanji, pictorial icons, decorative elements and logos. In addition, the graphical information may be presented in a variety of fonts, colors or styles.

Printer 28 need not be a thermal imaging printer. The invention encompasses production using other kinds of printers, such as laser printers and ink jet printers.

A printed panel may be bonded to a blank with a bonding apparatus such as a laminator 30. In embodiments in which a panel includes a pressure sensitive adhesive, laminator 30 may use pressure to secure the printed panel to the blank. The invention encompasses other bonding techniques as well, such as hot melt adhesion.

The bonding should be generally permanent, i.e., the panel and blank should not be separable after bonding, or separation cannot be accomplished without damaging the blank, the panel, or both. As a result, it should be very difficult for a person to tamper with a lawfully issued license plate without leaving an indication that tampering has occurred, or it should be very difficult for a person to tamper with a lawfully issued license plate without rendering the components unusable. Preferably, at least one security element is provided in such a manner that the security element is damaged or destroyed upon tampering, such as removal of the top film.

The invention is not limited to printing to a panel and securing the printed panel to a blank having retroreflective sheeting. The invention also encompasses printing to sheeting, then bonding the sheeting to a blank. The invention further encompasses printing to sheeting that is already bonded to a blank. In these variations, a protective cover layer, preferably a top film may be bonded to the sheeting.

The license plate may be finished with a finishing die 32 to create an embossed or debossed rim. The finished license plate may be inspected with a scanner 34 and recorded in a local database 36, as will be discussed below. The finished plate may also be inspected by an operator. The results of the inspection by the operator may be entered into client computer 18 with an input/output device such as a handheld bar code scanner 38. When the finished license plate passes inspection, the finished plate is ready for use.

In the case of personal identification cards such as national identification cards, the first component (e.g. blank) is typically paper or more often a plastic sheet. The paper or sheet may be provided with pre-printed (e.g. encrypted) information that uniquely identifies the first component. Custom or standard identification information may be printed at a branch office (e.g. upon providing proper verification to the operator at the branch office). Additional custom security features associated with for example military service status may be added as well. The military service identification number or marking may be authorized or denied by the server computer. A transparent cover layer (e.g. top film, transparent coating) may be laminated over the printed information. A second security element may be present in such cover layer, disposed between the blank and the cover layer, or provided on the exposed surface of the cover layer.

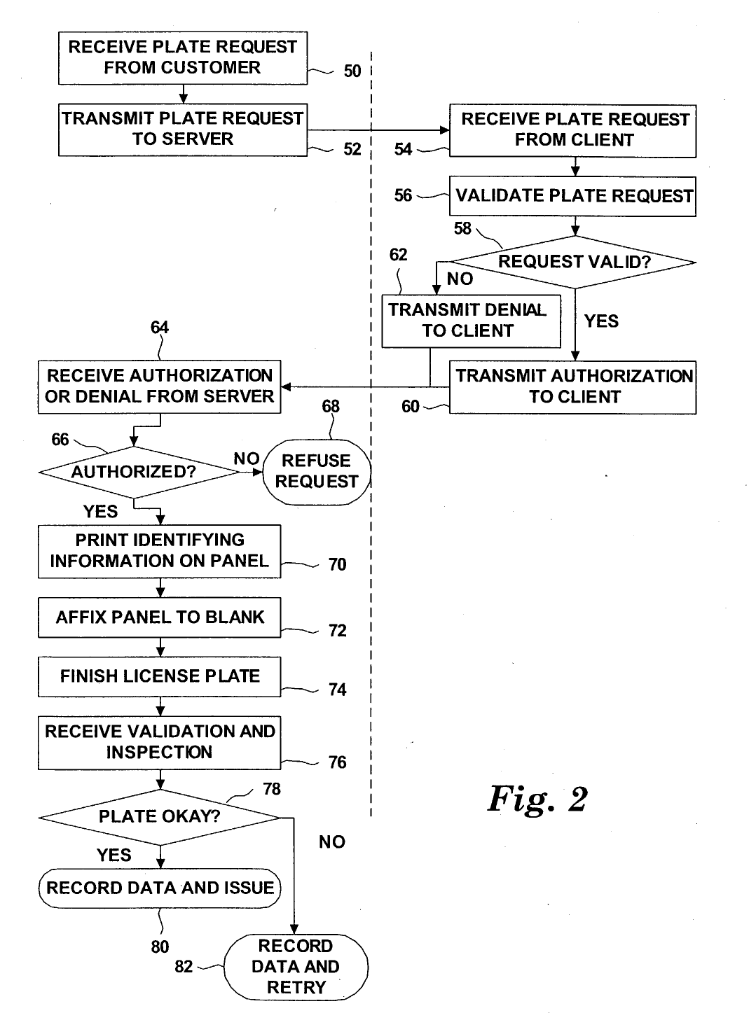

FIG. 2 is a flow diagram illustrating central management of license plate production according to the invention. Initially, client computer 18 receives a license plate request from a customer (50). The license plate request may include an identifier chosen by the customer. The license plate request is transmitted to server computer 22 (52) via network 16. For security, the transmission may be encrypted. Server computer 22 receives the plate request (54) and decrypts the request.

Server computer 22 validates the license plate request (56). Validation may include querying jurisdictional database 24 to determine whether the identifier requested by the customer has been previously assigned to another customer. Validation may also include querying jurisdictional database 24 to determine whether the identifier requested by the customer is restricted. Restricted identifiers may include, for example, identifiers that are limited to law enforcement personnel and identifiers that include obscene or otherwise inappropriate messages. Validation may also involve checking the legal status of the customer, whether the customer is licensed to drive, and whether the customer has any outstanding warrants, unpaid fines, and the like.

Server computer 22 makes a determination whether the request is valid or not (58). If the request is valid, server computer 22 transmits an authorization to client computer 18 (60). The authorization may include an authorization code. Otherwise, server computer 22 transmits a denial to client computer 18 (62). The authorization or denial may be encrypted.

Client computer 18 receives the authorization or denial (64) and decrypts the received transmission. A license plate may not be printed without a valid authorization, and when no valid authorization is received (66), the license plate request is denied (68). When a valid authorization is received (66), the requested identifier and other information may be printed to a panel, according to the license plate request (70). The panel may be affixed to a blank (72) and finishing touches may be applied (74).

The finished license plate may be validated and inspected (76). Validation may comprise performing a security check on the license plate, and inspection may include an examination of the license plate for defects. Validation and inspection will be described in more detail below. In the event the finished license plate passes validation and inspection, then the plate may be recorded as an issued license plate (80). In the event the finished license plate fails to pass validation or inspection, however, then data about the plate may be recorded (82). In particular, the blank and panel used to make the plate may be recorded as not issued, and the unsatisfactory plate may be retained so that branch office 12 may account for all blanks and panels. The license plate may be reprinted with or without requesting further authorization (82).

Security is of considerable importance in the issuance of license plates. A license plate production system 10 according to the invention includes safeguards to prevent and/or deter fraud and counterfeiting. In addition, a license plate production system 10 according to the invention includes safeguards to prevent and/or deter unauthorized printing of plates at a branch office 12. The invention includes security features that may be practiced individually or collectively. Security features may be included in the materials that make up the license plate, the hardware used to print the license plate, the computer software employed to print the license plate, or any combination of these.

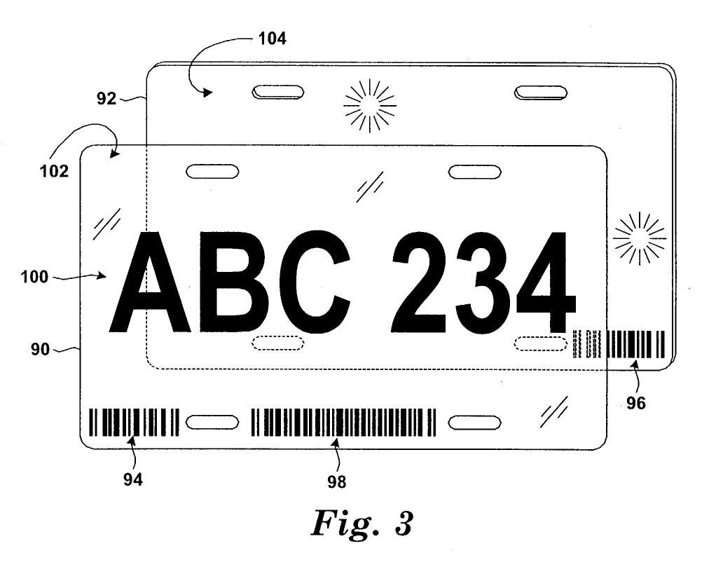

FIG. 3 illustrates security features that may be included in security components used to make up the license plate, e.g., a top film panel 90 and a blank 92. Top film panel 90 and blank 92 may be separately secured. For example, a roll of top film panels may include graphical information preprinted to each panel. This preprinted graphical information may include a security element, which may be unique to each panel. Each security element may include a tracking number or other tracking identifier, so that distributed license plate production system 10 can account for each panel. The security element may include encrypted information to make the security element difficult to decode or to forge without a decryption key.

For purposes of illustration, a preprinted security element is illustrated as a bar code 94. The invention is not limited to a bar code, however, but may include other security elements such as dot codes, color-shifting marks, watermarks, holographic marks, marks visible in ultraviolet (UV) or infrared (IR) light, marks that include specular reflection shifts, such as metallic gold, silver or pearlescent marks, and marks of specific colors, many of which may be visibility shifting (i.e., visible at certain viewing angles and invisible at other viewing angles). Many marks of these types may be applied to the top film by printing such as thermal transfer printing or flexographic printing. A color-shifting mark, for example, may be formed using a donor such as a thermal transfer ribbon that includes an ink that appears to change colors when viewed from different vantage points. The marks may encode information according to an encryption routine that can help reduce production of fraudulent plates.

Blank 92 may also include a unique security element. Although represented in FIG. 3 as a bar code 96, the security element may also include a dot code, color-shifting marks, holographic marks, and the like. An applied coating to blank 92 may also include a security element. The coating may include colored glass beads, for example, that give blank 92 a distinct appearance when the coating cures into a film. The security elements may be unique to each blank, and may include a tracking number or other tracking identifier so that distributed license plate production system 10 can account for each blank. The security element may include encrypted information to make the security element difficult to decode or to forge without a decryption key. Security element 96 on blank 92 may be applied by a variety of techniques, such as thermal transfer printing, flexographic printing or laser marking. The nature of the security element may depend upon the printing technique. Security elements made with laser marking, for example, may be real or virtual holographic images that seem to “float” above or below the surface of blank 92 and that change position depending upon viewing angle. Preferred security elements particularly for retroreflective blanks include those marks described in U.S. Pat. Nos. 4,634,220, 6,288,842, 6,120,882 and 6,024,455. Further, hot or cold stamp foil marks may be applied to the blank, top film, or to the constructed plate.

In a typical application, panels and blanks are separately secured before delivery to branch office 12. In other words, branch office 12 may receive panels with unique security elements and blanks with unique security elements. The security elements facilitate identification and tracking of panels and blanks independently of one another. The security elements also serve as obstacles to the creation of counterfeit panels or blanks. Separately secured panels and blanks make forgery or counterfeiting of a finished license plate more difficult.

When a panel 90 is printed at branch office 12 for attachment to a blank 92, one or more additional security elements may be applied to the panel during the printing process. The security element printed at branch office 12 may include encrypted information, such as the chosen identifier, information about the vehicle to which the license plate was issued, and/or information about the owner of the vehicle. In FIG. 3, the security element printed at branch office 12 is represented as a bar code 98, although the security element may also include a dot code, color-shifting marks, holographic marks, and the like. As a result, a finished plate may include at least one first security element 94 for the panel, at least one second security element 96 for the blank, and at least one third security element 98 for the finished license plate.

Security elements 94, 96 of panel 90 and blank 92 may be readable after panel 90 and blank 92 are combined into a finished license plate. In FIG. 3, security element 98 and an identifier 100 are mirror-printed to one side 102 of transparent top film panel 90, and panel 90 is bonded to the reflective face 104 of blank 92. In addition to identifier 100 and security element 98, additional graphical information (not shown) may be printed to panel 90, such as symbols representing the jurisdiction or the intended use of the vehicle.

In the example of FIG. 3, each security element 94, 96, 98 is visible and may be inspected with bar code scanner 34 or 38. Security elements 94, 96, 98 confirm that the final product is a valid license plate comprising a valid blank and a valid panel.

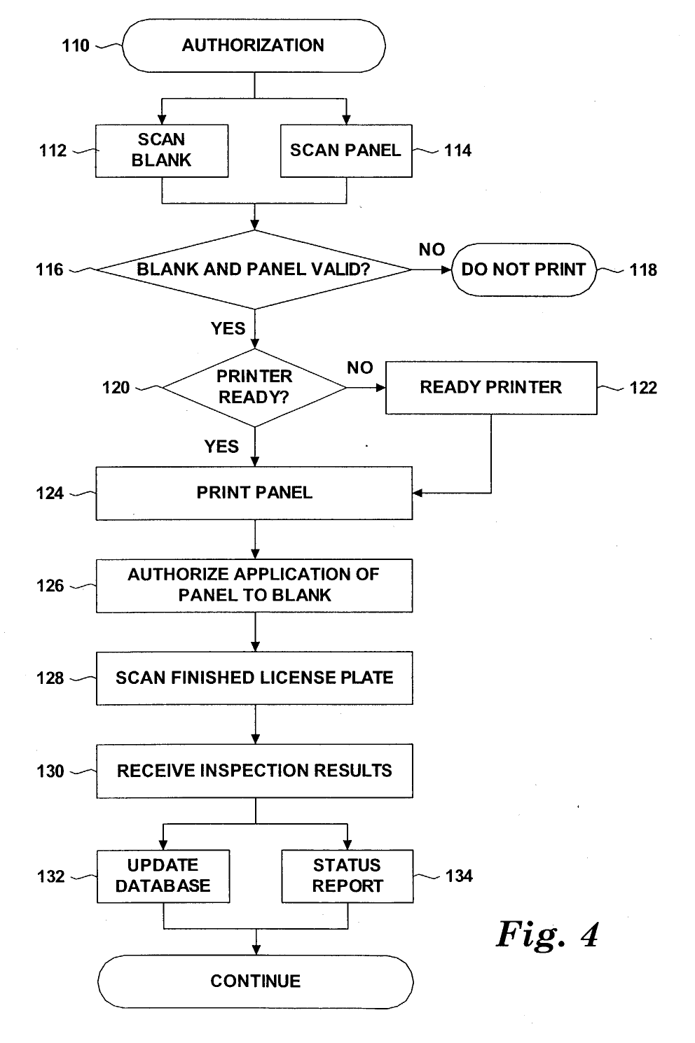

FIG. 4 shows an exemplary printing and inspection process. Upon receiving authorization (110) from server computer 22, client computer 18 begins printing. Security elements 94, 96 on panel 90 and blank 92 may be scanned (112, 114) with scanner 34 or 38. Scanning (112, 114) may be employed to inspect for a valid panel and a valid blank, i.e., to assure that the panel and blank are within the authorized inventory of branch office 12. Because branch office 12 may print license plates of different sizes and shapes, scanning (112, 114) may also be employed to verify that the panel and blank are the proper size and shape. In some embodiments, the security elements carried by blank 92 or panel 90 may be realized by magnetic markers or radio-frequency identification (RFID) tags that may carry encrypted security information and be scanned magnetically or via a radio frequency scanner, respectively. If the blank and panel are not valid (116), the panel is not printed (118) and suitable corrective action is taken. Corrective action may include suspending printing until the problem is resolved. In some embodiments, the problem may be resolved and the printing process restarted upon intervention of a supervisor, a timeout followed by entry of valid information, or some other event that enables the printing process.

If the blank and panel are valid (116), client computer 18 checks the status of printer 28 to verify that printer 28 is on line and ready to print a top film panel of the proper size and shape. If printer 28 is not ready (120), corrective action may be taken (122). When printer 28 is ready, client computer 18 directs printer 28 to print the panel (124). Printing may include an identifier 100 and a security element 98.

After the panel is printed, the panel may be applied to a blank. Although the panel may be applied to the blank with laminator 30 and finished with finishing die 32 by hand, client computer 18 may authorize and/or direct the use of laminator 30 and finishing die 32 (126), as will be described below.

The finished plate may be subject to automated and visual inspection. Automated inspection may include scanning the finished license plate with scanner 34 (128). Scanning may include verifying panel security element 94, blank security element 96 and finished license plate security element 98.

In addition, an operator may visually inspect the finished plate for defects and may supply the results of the inspection to client computer 18 (130). When the finished license plate passes inspection, the operator may so report. Otherwise, the operator may specify the defect or defects in the finished plate. Defects may include bad printing, bad lamination, bad finishing embossment or debossment, damaged plate, bad materials, incorrect size or shape, and so forth. In one application of the invention, an operator may have a menu of inspection options, with each option accompanied by a bar code. The operator may enter the results of the inspection by scanning the appropriate bar codes with hand-held scanner 38. For example, different bar codes on a bar code sheet may indicate bad printing, bad lamination, bad finishing embossment or debossment, damaged plate, bad materials, or incorrect size or shape. In another application of the invention, client computer 18 may display a menu of inspection options on a display screen, and the operator may select the appropriate options with a keyboard, mouse, stylus or other input/output device. As a security feature, client computer 18 may suspend further printing until an operator enters the results of the inspection.

Following inspection, client computer 18 may update local database 36 (132). In particular, client computer 18 may store information about the panel and blank used to make the finished plate, the identifier and codes applied to the finished plate, and the disposition of the finished plate. Client computer 18 may send this information to server computer 22 for storage in jurisdictional database 24 immediately or at a later time.

Client computer 18 may also issue a status report (134), authorizing delivery of the finished license plate to the customer or notifying the operator that the finished license plate is to be retained. When the license plate passes inspection, the license plate may be delivered to the customer. When the license plate fails inspection, the license plate is retained. Branch office 12 may be held accountable for panels and blanks of defective license plates, which may be returned to the central entity charged with issuing license plates.

When a license plate fails inspection, client computer 18 may attempt a new printing with a new blank and a new panel, and the procedures shown in FIG. 4 may be repeated.

In addition to security features in the materials, security features may be incorporated in the hardware and/or software used to generate the finished license plate. Client computer 18 may incorporate security codes such as passwords that prevent unauthorized personnel from accessing client computer 18. In addition, client computer 18 may control operation of equipment used to create finished license plates, such as printer 28, laminator 30 and finishing die 32. Client computer 18 may include a hardware encryption key (HEK) for security. The HEK may, for example, encrypt transmissions to server computer 22, hold passwords to access local database 36 and to enable or disable equipment 28, 30, 32, and prevent client computer 18 from using equipment other than authorized equipment.

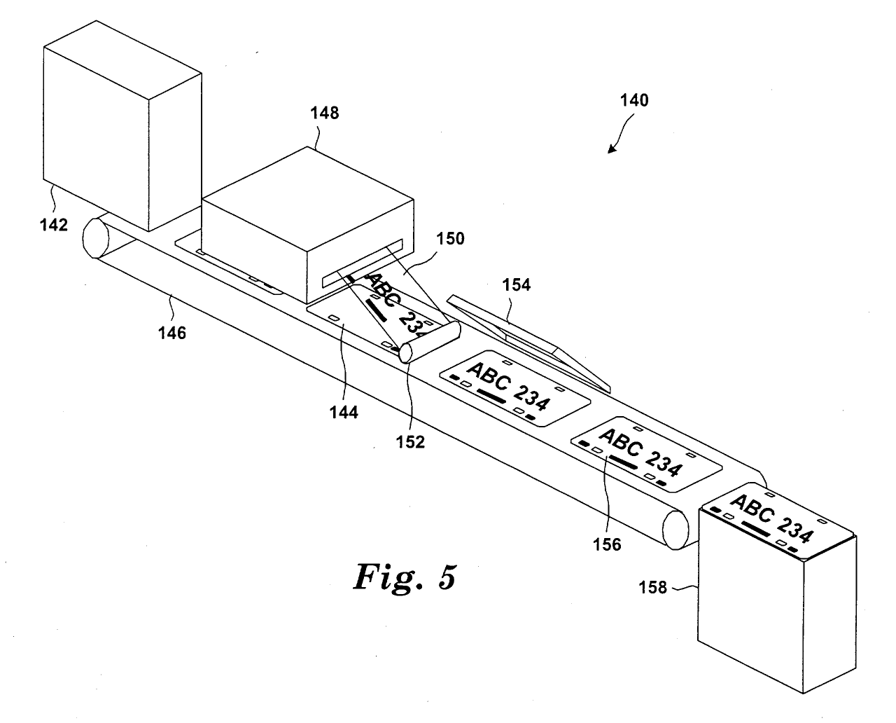

FIG. 5 shows an alternate embodiment of the invention, in which production of license plates is automated. Automated system 140 operates under the control of client computer 18 (not shown in FIG. 5). Automated system 140 applies techniques similar to the production described above, but reduces operator involvement. FIG. 5 shows a single license plate at various stages of production.

A hopper 142 holds a supply of blanks and feeds a blank 144 to a conveyor system 146. Conveyor system 146 may include a jig (not shown) to hold blank 144 in position. Conveyor system 146 brings blank 144 to printer 148. Printer 148 may be a thermal transfer printer. An application head (nor shown) may move a printed panel 150 forward. A bonding apparatus 152 such as an application roller may laminate or otherwise bond printed panel 150 to blank 144, and an automated finishing device 154 may apply finishing touches, such as debossing. The finished plate 156 may be driven to a receptacle 158. Automated system 140 may also include a scanner (not shown) that automatically inspects security elements.

An operator may retrieve a finished license plate from receptacle 158 for a visual inspection. The operator may enter the results of the inspection into client computer 18, and may deliver or retain the finished license plate, as appropriate. Client computer 18 may update local database 36. Client computer 18 may send this information to server computer 22 for storage in jurisdictional database 24 right away or at a later time.

Automated system 140 may be less expensive than conventional license plate production systems, and may operate with little or no human labor. Automated system 140 me be quiet and suitable for an office environment. In one application, the “footprint” of automated system 140 may be about 8 feet by 3 feet (2.4 meters by 0.9 meters).

The invention encompasses variations upon system 140, including systems that are less than fully automated. For example, blank 144 may be fed manually to bonding apparatus 152, and the printed panel 150 may be fed to bonding apparatus 152 automatically, or vice versa. In one embodiment, blank 144 and printed panel 150 may both be fed manually to bonding apparatus 152. In some cases, it may be possible to make system 140 more compact, with a smaller “footprint,” by eliminating some of the automation, such as eliminating devices that move the plate from bonding apparatus 152 to finishing device 154.

System 140 may also include components in addition to the components depicted in FIG. 5. For example, system 140 may include a component that applies an adhesive layer to blank 144. In an embodiment that uses blanks with a removable release liner over a previously applied adhesive layer, system 140 may include a component that removes the release liner from blank 144.

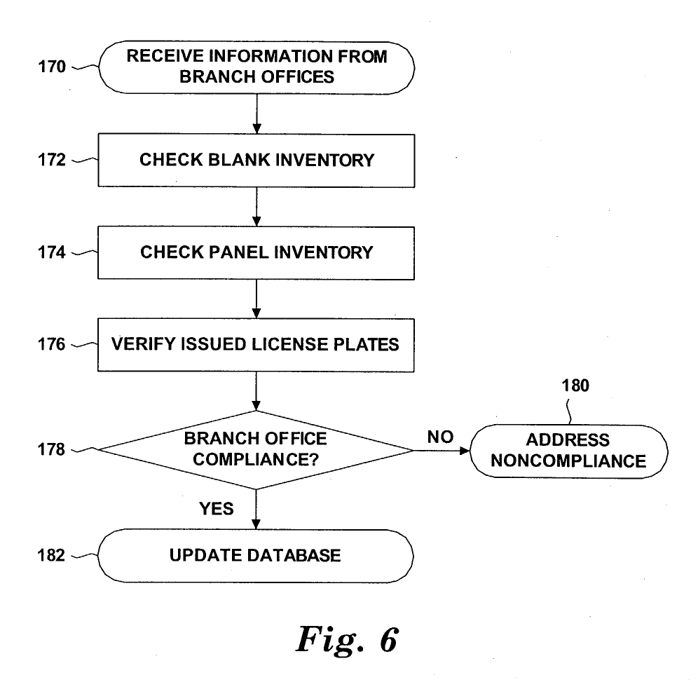

FIG. 6 shows the processing of information received by server computer 22 from client computer 18. Information from a branch office may include a list of license plates issued, license plates printed but not issued, blanks used and panels used (170). In particular, server computer 22 may receive the tracking numbers encrypted in the pre-printed security elements on the blanks and panels. Server computer 22 verifies that the blanks and panels conform to the inventory of the branch office (172, 174), helping to prevent use of counterfeit materials. Server computer 22 further confirms the issuance of license plates having identifiers for which authorization had been previously sought in plate requests (176). Server computer 22 determines whether the branch office has complied with proper procedures (178). Preferably, the server computer is a “dummy” terminal to a large extent and thus is not capable of printing in the absence of authorization from the central server computer.

If there is a discrepancy in the inventory of blanks, the inventory of panels or the inventory of issued license plates (178), server computer 22 may determine that the branch office has not complied with proper procedures. Server computer 22 may address the noncompliance (180) by, for example, suspending further production authorizations to the offending branch office.

The invention may provide many advantages. The distributed production system is advantageous to the customer, who can conveniently order customized license plates and have them printed on the spot. The convenience also benefits the issuing authority by using branch offices for distribution of license plates. A digital printing system such as a thermal imaging printing system may have the flexibility to print license plates with a variety of distinct formats, including distinct fonts and symbols for different classifications of vehicles or operators. The branch office may thereby be equipped to distribute license plates for several vehicle and/or operator classifications.

The security features may be advantageous in several respects. The security elements may deter or prevent forgery and counterfeiting. In particular, separate security elements on the blank, the panel and the finished plate make forgery prohibitively difficult. The security elements may also include encrypted information that increases the difficulties associated with forgery. In the event a counterfeit plate is produced, the encrypted information may be used to expose the fakery. The encrypted information may be visible on the face of the finished license plate, for example, and can be scanned by law enforcement personnel equipped with a portable scanner. The security elements are also useful for tracking or making inventory of materials used to make license plates.

Furthermore, the encrypted communications between client computer 18 and server computer 22 provide additional security. Encrypted data transfer prevents a prospective forger from intercepting data and using the data to create a false license plate.

Although the invention has been described in the context of license plate production, the invention may be used in the production of other controlled certificates as well. A branch office may generate controlled certificates subject to receipt of authorization from a central office. A client computer at a branch office may transmit a controlled certificate request to a server computer, which may authorize or deny the request.

The server computer regulates whether a controlled certificate will be produced, and the client computer regulates the production of the controlled certificate. The client and server computers may employ security measures, such as encryption, to prevent unauthorized production of a controlled certificate. Production may be partly or entirely automated.

The controlled certificate may include two or more security components that make up the controlled certificate. The security components that make up a particular controlled certificate depend upon the certificate involved. Security components may include blanks, coatings, top films, and the like, and any number of security components may be combined to create a controlled certificate. In the following discussion, a controlled certificate will be described in terms of two security components, a substrate with a panel bonded thereto. Information such as identifying information may be printed to the panel at the branch office prior to bonding. The substrate may be formed from materials such as paper, polymers, metals or any combination thereof. The bonding should be generally permanent, so that it should be very difficult for a person to tamper with a lawfully issued controlled certificate without leaving an indication that tampering has occurred.

The substrate and panel may each include security elements and the controlled certificate may also include a security element. Examples of security elements are provided above. Each security element may include a tracking number or other tracking identifier, and may include encrypted information to make the security element difficult to decode or to forge without a decryption key. Security elements may be validated before and after printing, and the finished controlled certificate may be subject to visual inspection.

A system for producing a controlled certificate may be similar to that depicted in FIG. 5. For example, the system includes a supply of substrates and a supply of panels. Each substrate and panel may have a unique security element. The system further includes a printer that prints informational content on the panels and a bonding apparatus that bonds the panels to the substrates. The system may also have a finishing device that applies finishing touches to the controlled certificate. The system may be partially or fully automated.

Various implementations and embodiments of the invention have been described. Nevertheless, it is understood that various modifications can be made without departing from the invention. For instance, the security elements and placement thereof are merely exemplary. The invention is not limited to the particular security elements or placements shown. Indeed, an advantage of the invention is that any central entity charged with issuing license plates or other controlled certificates may choose its own security elements.

Furthermore, the security procedures are illustrative of the practice of the invention and the invention is not limited to the procedures described. In FIG. 4, for example, the panel and blank are scanned before printing and after printing. The invention encompasses embodiments in which the panel and blank are scanned only once, such as after printing is completed.

The invention encompasses a variety of printing techniques and bonding techniques, and is not limited to the particular techniques described herein. For example, the invention is not limited to printing a mirror image of informational content on a panel of top film. The invention includes embodiments in which informational content is printed in a conventional orientation on an exposed surface. These and other embodiments are within the scope of the following claims.

1. An article of manufacture comprising a controlled certificate, the controlled certificate comprising:
a first component comprising a first security element; and
a second component comprising a second security element bonded to the first component.

2. The article of claim 1, wherein the controlled certificate comprises at least one of a vehicle registration sticker, a vehicle validation sticker, a driver license, a passport, a visa, and a personal identification card.

3. The article of claim 1 wherein at least one security element uniquely identifies the component.

4. The article of claim 3, wherein the security element that uniquely identifies the component uniquely identifies the controlled certificate.

5. The article of claim 3, wherein the security element that uniquely identified the component comprises encrypted information.

6. The article of claim 1 wherein the first security element uniquely identifies the first component and the second security element uniquely identifies the second security element.

7. The article of claim 6 wherein the first security element in combination with the second security element uniquely identify the controlled certificate.

8. The article of claim 1, wherein the security element comprises at least one of a bar code, a dot code, a color-shifting mark, a watermark, a holographic mark, a visibility-shifting mark, a mark visible in ultraviolet light, a mark visible in infrared (IR) light, a mark that includes a specular reflection shift, a mark of a specific color, a foil mark and a radio frequency identification tag.

9. The article of claim 1, further comprising informational content printed to at least one of the components.

10. The article of claim 1, wherein the first component is bonded to the second component with an adhesive.

11. The article of claim 1, wherein the first component is selected from paper, a polymeric sheet and a metal.

12. The article of claim 1 wherein the second component is selected from transparent film and transparent coating.

13. A system comprising:
a client computer, associated with a branch office, that transmits a controlled certificate request via a computer network;
a server computer that receives the controlled certificate request from the client computer via the computer network, and transmits a response to the controlled certificate request to the client computer via the computer network, the response including one of an authorization and a denial of the controlled certificate request; and
a printer coupled to the client computer to generate at least a portion of a controlled certificate when the client computer receives an authorization of the controlled certificate request.

14. The system of claim 13, wherein the controlled certificate comprises at least one of a license plate, a vehicle registration sticker, a vehicle validation sticker, a driver license, a passport, a visa, and a personal identification card.

15. The system of claim 13, wherein the transmitted controlled certificate request is encrypted.

16. The system of claim 13, wherein the transmitted response to the controlled certificate request is encrypted.

17. The system of claim 13, wherein the controlled certificate comprises at least two security components.

18. The system of claim 17, wherein the security components comprise a panel and a substrate.

19. The system of claim 17, further comprising a scanner coupled to the client computer to read at least one security element on at least one security component.

20. The system of claim 17, further comprising a bonding apparatus coupled to the client computer that bonds at least one security component to another security component.

21. A method comprising:
receiving a controlled certificate request;
transmitting the controlled certificate request to a server computer;
receiving a response to the controlled certificate request from the server computer, the response including one of an authorization and a denial of the controlled certificate request; and
generating a controlled certificate according to the controlled certificate request when an authorization is received.

22. The method of claim 21, wherein the controlled certificate comprises at least one of a license plate, a vehicle registration sticker, a vehicle validation sticker, a driver license, a passport, a visa, and a personal identification card.

23. The method of claim 21, wherein generating a controlled certificate comprises printing a panel with identifying information, the panel configured to be bonded to a substrate.

24. The method of claim 23, wherein the panel includes at least one first security element and the substrate includes at least one second security element, the method further comprising scanning the first and second security elements.

25. The method of claim 24, wherein the second security element comprises at least one of a bar code, a dot code, a color-shifting mark, a watermark, a holographic mark, a visibility-shifting mark, a mark visible in ultraviolet light, a mark visible in infrared (IR) light, a mark that includes a specular reflection shift, a mark of a specific color, a foil mark and a radio frequency identification tag.

26. The method of claim 23, wherein printing the panel comprises printing a security element unique to the controlled certificate.

27. A method comprising:
receiving a receiving a controlled certificate request from a branch office;
validating the controlled certificate request; and
authorizing the branch office to generate a controlled certificate according to the controlled certificate request when the controlled certificate request is valid.

28. The method of claim 27, wherein the controlled certificate comprises at least one of a license plate, a vehicle registration sticker, a vehicle validation sticker, a driver license, a passport, a visa, and a personal identification card.

29. The method of claim 27, further comprising:
receiving encrypted information associated with the generated controlled certificate; and
recording the information in a database.

30. A system comprising:
a computer that is authorized to generate a controlled certificate comprising a first security component and a second security component; and
a digital printer coupled to the computer to print informational content and a first security element on at least one of the first and second security components,
wherein the first security component includes a second security element prior to printing, and
wherein the second security component includes a third security element prior to printing.

31. The system of claim 30, wherein the first security component comprises a panel and the second security component comprises a substrate.

32. The system of claim 30, further comprising a scanner that reads at least one of the first, second and third security element.

33. The system of claim 30, wherein at least one security element comprises at least one of a bar code, a dot code, a color-shifting mark, a watermark, a holographic mark, a visibility-shifting mark, a mark visible in ultraviolet light, a mark visible in infrared (IR) light, a mark that includes a specular reflection shift, a mark of a specific color, a foil mark and a radio frequency identification tag.

34. The system of claim 30, wherein the computer is a client computer, and wherein the client computer receives the authorization to generate the controlled certificate from a server computer.

35. The system of claim 30, further comprising a bonding apparatus that bonds the first security component to the second security component.

36. The system of claim 35, further comprising a conveying apparatus that moves at least one of the first security component and second security component to the bonding apparatus.

37. The system of claim 30, wherein the system is automated.

38. The system of claim 30, wherein the controlled certificate comprises at least one of a driver license, a passport, a visa, and a personal identification card.

39. The system of claim 30, further comprising a hopper to hold at least one of a first and second security component.

40. The system of claim 30, further comprising a finishing device.

41. A method comprising:
receiving from a branch office a first tracking identifier that identifies a first security component used in making a controlled certificate;
receiving from the branch office a second tracking identifier that identifies a second security component used in making the controlled certificate; and
verifying that the first and second security components are in the inventory of the branch office.

42. The method of claim 41, further comprising receiving from the branch office a controlled certificate tracking identifier that identifies the controlled certificate.

43. The method of claim 41, wherein the controlled certificate comprises at least one of a driver license, a passport, a visa, and a personal identification card.

44. The method of claim 41, further comprising recording the first and second tracking identifiers in a database.

45. The method of claim 40, wherein the first security component comprises a panel and the second security component comprises a substrate.
